(19) United States
(12) Patent Application Publication
(10) Pub. No.: US 2025/0371672 A1
(43) Pub. Date: Dec. 4, 2025

(54) IMAGE PROCESSING CIRCUIT AND IMAGE PROCESSING METHOD

(71) Applicant: Sigmastar Technology Ltd., Xiamen (CN)

(72) Inventors: Chengzhi Xie, Shenzhen (CN); Yujie Qiu, Shanghai (CN); Wei Zhu, Shanghai (CN)

(21) Appl. No.: 18/980,057

(22) Filed: Dec. 13, 2024

(30) Foreign Application Priority Data
May 30, 2024 (CN) 202410693093.4

(51) Int. Cl. G06T 5/50

(52) U.S. Cl. CPC G06T 5/50; G06T 2207/20016; G06T 2207/20221

(57) ABSTRACT

An image processing circuit for performing an image stitching operation is coupled to an external memory storing an original image containing adjacent first and second slices, and includes a memory, a Gaussian pyramid calculation circuit, and a Laplacian pyramid calculation circuit. The first slice contains a first image tile. The Gaussian pyramid calculation circuit reads a portion of the original image from the external memory, generates a Gaussian pyramid for the first image tile, with the Gaussian pyramid containing N image layers, stores N−1 rows of pixels into the memory, with the N−1 rows of pixels being respectively the last row of N−1 image layers among the N image layers, and stores the Gaussian pyramid into the memory. The Laplacian pyramid calculation circuit reads the N−1 rows of pixels from the memory when generating a corresponding Laplacian pyramid for a second image tile of the second slice.

This application claims the benefit of China application Serial No. 202410693093.4, filed on May 30, 2024, the subject matter of which is incorporated herein by reference.

### BACKGROUND OF THE INVENTION

### 1. Field of the Invention

The present invention generally relates to image processing, and more particularly, to an image processing circuit and method of image stitching.

### 2. Description of Related Art

Reference is made to FIG. 1, which is a schematic diagram of an original image. The original image 100 includes multiple slices (S_k−1, S_k, S_k+1, . . . , where k is an integer greater than or equal to 1), and each slice contains M rows of pixels (Ln_0, Ln_1, Ln_2, . . . , Ln_M−1, where M is an integer greater than or equal to 1). Each row of pixels contains W*1 pixels, where W is the width of the original image 100. The visible area 110 includes multiple image tiles: T_k−1_p−1, T_k−1_p, T_k−1_p+1, T_k_p−1, T_k_p, T_k_p+1, T_k+1_p−1, T_k+1_p, and T_k+1_p+1. The size of each image tile is M*M pixels. The visible area 110 indicates the data range required for performing image operations (e.g., image stitching) on the image tile T_k_p. The range of the visible area 110 is related to the algorithm of the image operation.

Reference is made to FIG. 2, which is a flowchart of the conventional image stitching operation. Assuming that the image stitching operation is to be performed on a first image and a second image, the image stitching operation first performs, in units of image tiles, the operations of steps S210 to S230 on a target image tile of the first image and a target image tile of the second image to respectively generate a first Gaussian Pyramid and a second Gaussian Pyramid (step S210), to respectively generate a first Blur Pyramid and a second Blur Pyramid based on the first Gaussian Pyramid and the second Gaussian Pyramid (step S220), and to respectively generate a first Laplacian Pyramid and a second Laplacian Pyramid based on the first Gaussian Pyramid, the second Gaussian Pyramid, the first Blur Pyramid, and the second Blur Pyramid (step S230). Then, the two Laplacian pyramids are blended (e.g., using alpha blending (a-blending)) to generate the blended pyramid (step S240). Finally upsampling is performed on the blended pyramid to generate the stitched image tile (step S250). The flow of FIG. 2 is repeated to process the other image tiles of the first image and the second image. The operational details for generating a Gaussian pyramid, a Blur pyramid, and a Laplacian pyramid are well known to people having ordinary skill in the art, so further elaboration is omitted for brevity.

Due to the overlapping visible area of adjacent image tiles (e.g., the image tiles T_k_p and T_k+1_p, or the image tiles T_k_p and T_k_p+1), the image stitching operation has redundantly calculated and/or redundantly stored data, which reduces the performance of the image processing device.

### SUMMARY OF THE INVENTION

In view of the issues of the prior art, an object of the present invention is to provide an image processing circuit and an image processing method, so as to make an improvement to the prior art.

According to one aspect of the present invention, an image processing circuit is provided. The image processing circuit is coupled to an external memory and configured to perform an image stitching operation. The external memory stores an original image, and the original image contains a first slice and a second slice that are adjacent to each other. The first slice contains a first image tile. The image processing circuit sequentially processes the first slice and the second slice. The image processing circuit includes: a memory, a memory control circuit, a Gaussian pyramid calculation circuit, and a Laplacian pyramid calculation circuit. The memory control circuit is coupled to the memory. The Gaussian pyramid calculation circuit is coupled to the memory control circuit and configured to perform the following steps: reading a portion of the original image from the external memory; generating a Gaussian pyramid for the first image tile, wherein the Gaussian pyramid includes N image layers, and N is a positive integer greater than one; storing N−1 rows of pixels into the memory through the memory control circuit, wherein the N−1 rows of pixels are respectively the last row of N−1 image layers among the N image layers; and storing the Gaussian pyramid into the memory through the memory control circuit. The Laplacian pyramid calculation circuit is coupled to the Gaussian pyramid calculation circuit and the memory control circuit and configured to perform the following steps: reading the N−1 rows of pixels from the memory when generating a corresponding Laplacian pyramid for a second image tile of the second slice.

According to another aspect of the present invention, an image processing method of performing an image stitching operation is provided. The image processing method includes the following steps: reading a portion of an original image from an external memory, wherein the original image contains a first slice and a second slice that are adjacent to each other, the first slice contains a first image tile, and the image processing method sequentially processes the first slice and the second slice; generating a Gaussian pyramid for the first image tile, wherein the Gaussian pyramid includes N image layers, and N is a positive integer greater than one; storing N−1 rows of pixels into a memory, wherein the N−1 rows of pixels are respectively the last row of N−1 image layers among the N image layers; storing the Gaussian pyramid into the memory; and reading the N−1 rows of pixels from the memory when generating a corresponding Laplacian pyramid for a second image tile of the second slice.

According to still another aspect of the present invention, an image processing circuit is provided. The image processing circuit is coupled to an external memory and configured to perform an image stitching operation. The external memory stores an original image, and the original image contains a visible area centered on a first image tile. The visible area contains a second image tile. The image processing circuit processes the first image tile first and then processes the second image tile. The first image tile and the second image tile correspond to a first Gaussian pyramid and a second Gaussian pyramid, respectively. The image processing circuit includes a memory, a memory control circuit, a Gaussian pyramid calculation circuit, and a Laplacian pyramid calculation circuit. The memory control circuit is coupled to the memory. The Gaussian pyramid calculation circuit is coupled to the memory control circuit. The Laplacian pyramid calculation circuit is coupled to the Gaussian pyramid calculation circuit and the memory control circuit. When the image processing circuit is processing the first image tile, the memory has already stored the first Gaussian pyramid of the first image tile, the Gaussian pyramid calculation circuit generates the second Gaussian pyramid for the second image tile and stores the second Gaussian pyramid into the memory, and the Laplacian pyramid calculation circuit reads the first Gaussian pyramid from the memory.

The technical means embodied in the embodiments of the present invention can solve at least one of the problems of the prior art. Therefore, compared to the prior art, the present invention can reduce the amount of computation and decrease the bandwidth and/or capacity requirements for the memory.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a schematic diagram of an original image.

FIG. 2 is a flowchart of the conventional image stitching operation.

FIG. 3 is a functional block diagram of the electronic device according to an embodiment of the present invention.

FIG. 4 is a flowchart for generating a Gaussian pyramid according to an embodiment of the present invention.

FIG. 5 is a schematic diagram of the Gaussian pyramid.

FIGS. 6A and 6B are schematic diagrams of generating a Blur pyramid based on a Gaussian pyramid.

FIG. 7 is a flowchart for generating a Laplacian pyramid according to an embodiment of the present invention.

FIG. 8 is a flowchart for generating a Gaussian pyramid according to another embodiment of the present invention.

FIG. 9 is a flowchart for generating a Gaussian pyramid according to another embodiment of the present invention.

FIG. 10 is a flowchart for generating a Laplacian pyramid according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an image processing circuit and an image processing method. On account of that some or all elements of the image processing circuit could be known, the detail of such elements is omitted provided that such detail has little to do with the features of this disclosure, and that this omission nowhere dissatisfies the specification and enablement requirements. Some or all of the processes of the image processing method may be implemented by software and/or firmware and can be performed by the image processing circuit or its equivalent. A person having ordinary skill in the art can choose components or steps equivalent to those described in this specification to carry out the present invention, which means that the scope of this invention is not limited to the embodiments in the specification.

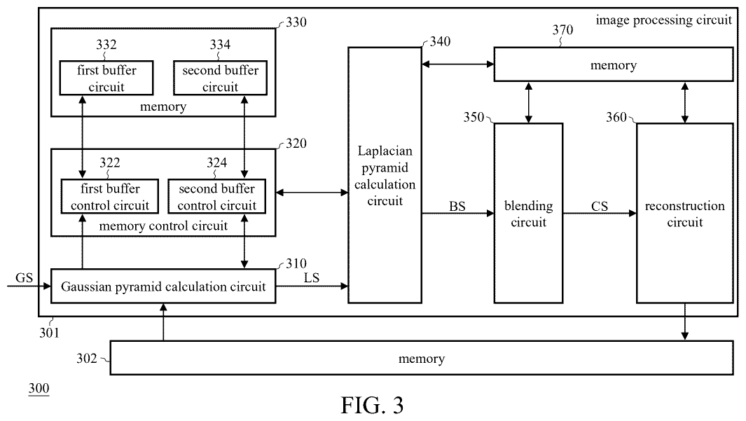

Reference is made to FIG. 3, which is a functional block diagram of the electronic device according to an embodiment of the present invention. The electronic device 300 includes an image processing circuit 301 and a memory 302. The image processing circuit 301 is coupled to the memory 302 (which is located outside the image processing circuit 301), and includes a Gaussian pyramid calculation circuit 310, a memory control circuit 320, a memory 330, a Laplacian pyramid calculation circuit 340, a blending circuit 350, a reconstruction circuit 360, and a memory 370, all of which are coupled to each other. The memory control circuit 320 includes a first buffer control circuit 322 and a second buffer control circuit 324. The memory 330 includes a first buffer circuit 332 and a second buffer circuit 334. The first buffer circuit 332 and the second buffer circuit 334 are respectively controlled by the first buffer control circuit 322 and the second buffer control circuit 324. The memory 330 and the memory 370 can be embodied by a Static Random Access Memory (SRAM). The memory 302 can be a dynamic random access memory (DRAM), and the memory 302 can store the raw data (pixel values) of the original image. In some embodiments, the Gaussian pyramid calculation circuit 310 can be embodied by a downsampling filter.

The Gaussian pyramid calculation circuit 310, the Laplacian pyramid calculation circuit 340, the blending circuit 350, and the reconstruction circuit 360 start operating according to the trigger signal GS, the trigger signal LS, the trigger signal BS, and the trigger signal CS, respectively. The trigger signal GS is generated by another circuit (e.g., a processing unit or a microcontroller), while the trigger signal LS, the trigger signal BS, and the trigger signal CS are generated by the Gaussian pyramid calculation circuit 310, the Laplacian pyramid calculation circuit 340, and the blending circuit 350, respectively.

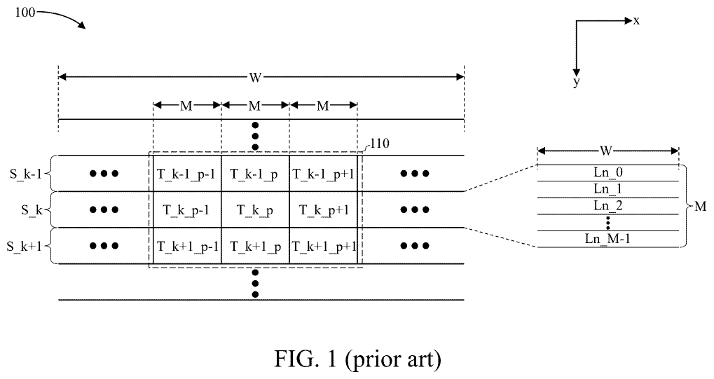

Reference is made to FIG. 1. In the following discussion, assume M=32. However, in an alternative embodiment, M may be other values (e.g., 4, 8, 16, . . . ). The image processing circuit 301 processes the image tiles in the order from left to right (x direction) and from top to bottom (y direction). That is to say, the image processing circuit 301 processes all image tiles of the slice S_k sequentially from left to right, and then processes all image tiles of the slice S_k+1 sequentially from left to right.

In the following discussion, the central image tile of the visible area is referred to as the target image tile, which is the image tile that the image processing circuit 301 is currently processing. Taking FIG. 1 as an example, the image tile T_k_p is the central image tile of the visible area 110.

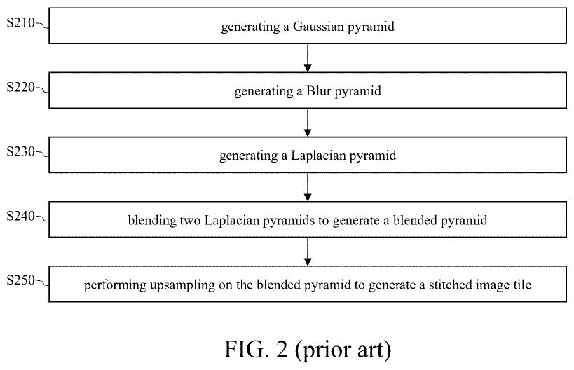

The image processing circuit 301 can perform the image stitching operation according to the flow in FIG. 2. The Gaussian pyramid calculation circuit 310 and the Laplacian pyramid calculation circuit 340 of the image processing circuit 301 optimize the image stitching operation through the memory control circuit 320 to reduce the amount of computation and decrease the bandwidth and/or capacity requirements for the memory 330. The details are elaborated as follows.

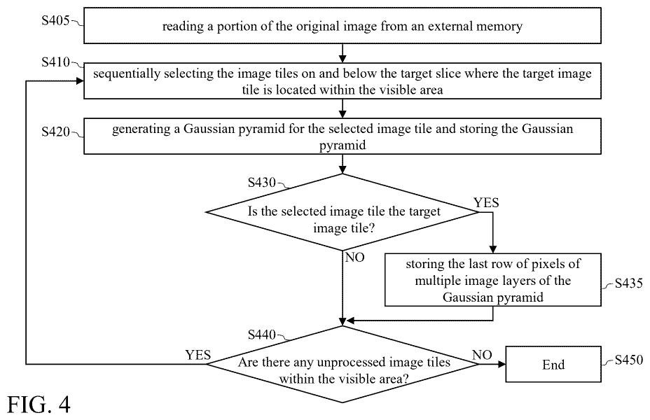

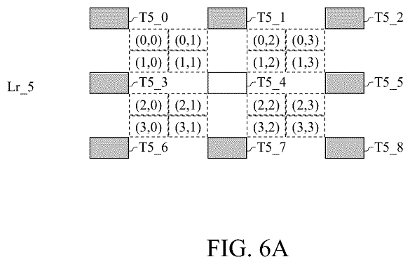

Reference is made to FIG. 4 and FIG. 5. FIG. 4 is a flowchart for generating a Gaussian pyramid according to an embodiment of the present invention, which is a part of the image processing method (image stitching) of the present invention. FIG. 5 is a schematic diagram of a Gaussian pyramid. A Gaussian pyramid contains at least one image layer. In the following discussion, the total number of layers in the Gaussian pyramid is exemplified as 6 (Lr_0 to Lr_5), where the image layer Lr_0 is a part of the original image 100 in FIG. 1. FIG. 4 includes the following steps.

Step S405: The Gaussian pyramid calculation circuit 310 reads a portion of the original image 100 from the external memory (i.e., the memory 302).

Step S410: The Gaussian pyramid calculation circuit 310 sequentially selects the image tiles on and below the target slice where the target image tile is located within the visible area 110. For example, reference is made to FIG. 1. When the target image tile is the image tile T_k_p, the target slice is the slice S_k; therefore, the Gaussian pyramid calculation circuit 310 will sequentially select the image tiles T_k_p−1, T_k_p, T_k_p+1, T_k+1_p−1, T_k+1_p, and T_k+1_p+1 for processing.

Step S420: The Gaussian pyramid calculation circuit 310 generates a Gaussian pyramid for the selected image tile and stores the Gaussian pyramid. As shown in FIG. 5, through multiple downsampling operations, the Gaussian pyramid calculation circuit 310 can sequentially generate the image layer Lr_1 (16*16 pixels), the image layer Lr_2 (8*8 pixels), the image layer Lr_3 (4*4 pixels), the image layer Lr_4 (2*2 pixels), and the image layer Lr_5 (1*1 pixel) based on the image layer Lr_0 (32*32 pixels). After generating the Gaussian pyramid, the Gaussian pyramid calculation circuit 310 stores the Gaussian pyramid into the memory 330 (more specifically, into the second buffer circuit 334) through the memory control circuit 320 (more specifically, through the second buffer control circuit 324).

In the example of FIG. 5, the downsampling operation is based on, for example but not limited to, the 4-point box filtering.

Step S430: The Gaussian pyramid calculation circuit 310 determines whether the selected image tile is the target image tile. If YES, then the flow proceeds to step S435; otherwise, the flow proceeds to step S440. In the example of FIG. 1, when the selected image tile is the image tile T_k_p, the result of step S430 is YES.

Step S435: The Gaussian pyramid calculation circuit 310 stores the last row of pixels of multiple image layers of the Gaussian pyramid into the memory 330 (more specifically, into the first buffer circuit 332) through the memory control circuit 320 (more specifically, through the first buffer control circuit 322). Referring to FIG. 5, the gray pixels are the pixels of the last row of each image layer, and these pixels are stored in the first buffer circuit 332.

It should be noted that since the last row of pixels in the image layer Lr 0 will not be referenced in the subsequent operation of generating the Blur pyramid, in some embodiments, this row of pixels may not be stored.

Step S440: The Gaussian pyramid calculation circuit 310 determines whether there are any unprocessed image tiles within the visible area 110. An unprocessed image tile refers to the situation where its corresponding Gaussian pyramid has not yet been generated. If YES, then the Gaussian pyramid calculation circuit 310 selects the next unprocessed image tile (step S410); if NO, the Gaussian pyramid calculation circuit 310 sends out the trigger signal LS, and then ends the process of FIG. 4 (step S450).

As shown in the flow of FIG. 4, when the Gaussian pyramid calculation circuit 310 processes the image tiles T_k−1_p−1, T_k−1_p, and T_k−1_p+1 (i.e., sequentially using these 3 image tiles as the target image tile), the Gaussian pyramid calculation circuit 310 additionally stores the last row of pixels of each image layer of the Gaussian pyramid of these 3 image tiles (step S435). As a result, when processing the target image tile T_k_p, the Gaussian pyramid calculation circuit 310 may not need to recalculate and store the Gaussian pyramid of the 3 image tiles of the previous slice (i.e., the slice S_k−1), which can enhance the performance of the image processing circuit 301.

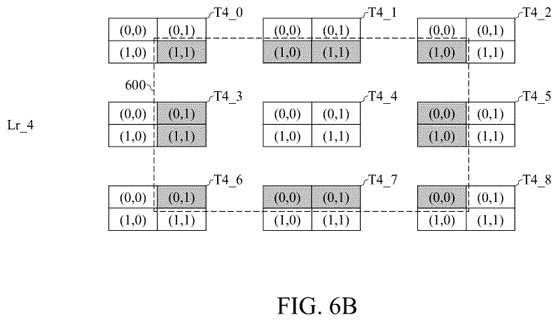

Reference is made to FIG. 6A and FIG. 6B. FIG. 6A and FIG. 6B are schematic diagrams of generating a Blur pyramid based on Gaussian pyramids. The examples in FIG. 6A and FIG. 6B perform upsampling based on the bilinear interpolation method. FIGS. 6A and 6B correspond to the image layer Lr_5 and the image layer Lr_4 of FIG. 5, respectively. People having ordinary skill in the art can understand the operation of the other image layers based on the discussion about FIG. 6A and FIG. 6B.

FIG. 6A shows nine image tiles: T5_0, T5_1, T5_2, T5_3, T5_4, T5_5, T5_6, T5_7, and T5_8, which correspond to the image tiles T_k−1_p−1, T_k−1_p, T_k−1_p+1, T_k_p−1, T_k_p, T_k_p+1, T_k+1_p−1, T_k+1_p, and T_k+1_p+1 of FIG. 1, respectively. The Laplacian pyramid calculation circuit 340 performs bilinear interpolation on the image tiles T5_0, T5_1, T5_3, and T5_4 to obtain the interpolated pixels (0,0), (0,1), (1,0), and (1,1). Similarly, the Laplacian pyramid calculation circuit 340 performs bilinear interpolation on the other image tiles to obtain the interpolated pixels (0,2), (0,3), (1,2), (1,3), (2,0), (2,1), (3,0), (3,1), (2,2), (2,3), (3,2), and (3,3). The interpolated pixels (a total of 16 in the example of FIG. 6A) form the image layer Lr_4 of the Blur pyramid.

As shown in FIG. 6A, the Laplacian pyramid calculation circuit 340 requires the eight image tiles (shown in gray) surrounding the target image tile T5_4 for bilinear interpolation. This explains the reason why the visible area 110 of FIG. 1 contains 9 image tiles. In other words, the size of the visible area 110 is related to the method used in the upsampling operation. It should be noted that the upsampling operation of the present invention is not limited to the bilinear interpolation method; people having ordinary skill in the art can determine the size of the visible area 110 according to the method used for the upsampling operation.

As shown in FIG. 6B, when the Laplacian pyramid calculation circuit 340 performs an upsampling operation on the target image tile T4_4 (corresponding to the image tile T_k_p in FIG. 1), a surrounding ring of pixels (a total of 12, shown in gray) is needed. These pixels are distributed in 8 image tiles around the target image tile T4_4. These 8 image tiles (T4_0, T4_1, T4_2, T4_3, T4_5, T4_6, T4_7, and T4_8) correspond to the image tiles T_k−1_p−1, T_k−1_p, T_k−1_p+1, T_k_p−1, T_k_p+1, T_k+1_p−1, T_k+1_p, and T_k+1_p+1 in FIG. 1, respectively. Similarly, the interpolated pixels generated in the upsampling operation on the image layer Lr_4 of the Gaussian pyramid form the image layer Lr_3 of the Blur pyramid.

In other words, in addition to the Gaussian pyramid of the target image tile, the Laplacian pyramid calculation circuit 340 also requires the Gaussian pyramids of the other image tiles in the visible area 110 to generate the Blur pyramid of the target image tile. As shown in FIG. 6A (6B), because among the 8 (12) gray pixels, the pixels belonging to the image tiles T5_0, T5_1, and T5_2 (T4_0, T4_1, and T4_2) have been previously stored into the first buffer circuit 332, the Gaussian pyramid calculation circuit 310 does not need to recalculate the Gaussian pyramid of those image tiles when processing the target image tile T5_4 (T4_4).

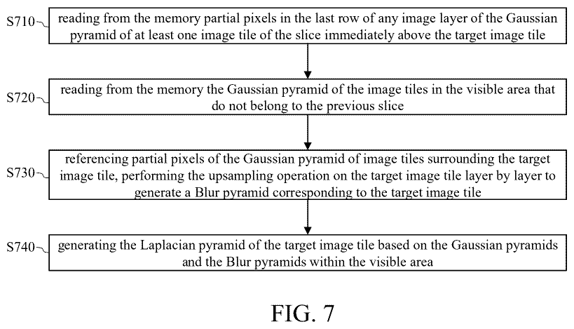

Reference is made to FIG. 7, which is a flowchart for generating the Laplacian pyramid according to an embodiment of the present invention. FIG. 7 is a part of the image processing method (image stitching) of the present invention, and includes the following steps.

Step S710: The Laplacian pyramid calculation circuit 340 reads partial pixels in the last row of any image layer of the Gaussian pyramid of at least one image tile of the previous slice immediately above the target image tile from the memory 330 (more specifically, from the first buffer circuit 332) through the memory control circuit 320 (more specifically, through the first buffer control circuit 322). For example, in reference to FIG. 1 and FIG. 6B, when the target image tile is the image tile T_k_p (T4_4), the previous slice is the slice S_k−1, the at least one image tile is the image tile T_k−1_p−1 (T4_0), T_k−1_p (T4_1), or T_k−1_p+1 (T4_2), the partial pixels in the last row include the pixel (1,1) of the image tile T4_0, the pixel (1,0) and the pixel (1,1) of the image tile T4_1, and the pixel (1,0) of the image tile T4_2.

Step S720: The Laplacian pyramid calculation circuit 340 reads the Gaussian pyramid of the image tiles in the visible area 110 that do not belong to the previous slice from the memory 330. For example, in reference to FIG. 1 and FIG. 6B, when the target image tile is the image tile T_k_p (T4_4), the image tiles not belonging to the slice S_k−1 include the image tiles T_k_p−1 (T4_3), T_k_p (T4_4), T_k_p+1 (T4_5), T_k+1_p−1 (T4_6), T_k+1_p (T4_7), and T_k+1_p+1 (T4_8). The Gaussian pyramids of these image tiles are generated and stored into the memory 330 by the Gaussian pyramid calculation circuit 310 in step S420 of FIG. 4.

Step S730: The Laplacian pyramid calculation circuit 340 references partial pixels of the Gaussian pyramid of image tiles surrounding the target image tile, performing the upsampling operation layer by layer on the target image tile to generate a Blur pyramid corresponding to the target image tile. Refer to the discussion about FIG. 6A and FIG. 6B. In some embodiments, the Laplacian pyramid calculation circuit 340 temporarily stores the Blur pyramid into the memory 370.

Step S740: The Laplacian pyramid calculation circuit 340 generates the Laplacian pyramid of the target image tile based on the Gaussian pyramids and the Blur pyramids within the visible area 110. More specifically, the J^{th} image layer of the Laplacian pyramid is equal to the J^{th} image layer of the Gaussian pyramid minus the J^{th} image layer of the Blur pyramid, where the top layer of the Gaussian pyramid is the 0th layer, and J is less than the total number of layers of the Gaussian pyramid minus 1. In the example of FIG. 5, the total number of layers of the Gaussian pyramid is 6 (Lr_0 to Lr_5), and J is an integer less than 5.

For example (refer to FIG. 6A and FIG. 6B), the image layer Lr_4 of the Blur pyramid, which contains 16 pixels, is equal to 16 pixels within the target range 600 of FIG. 6B minus 16 corresponding interpolated pixels in FIG. 6A. For example, the interpolated pixel (0,0) of FIG. 6A corresponds to the pixel (1,1) of the image tile T4_0 of FIG. 6B, the interpolated pixel (0, 1) corresponds to the pixel (1,0) of the image tile T4_1, and so on.

It should be noted that because the lowest layer of the Blur pyramid (taking FIG. 5 as an example, the lowest layer is the image layer Lr_5) cannot be obtained through the interpolation of the Gaussian pyramid (because the Gaussian pyramid does not have data from a further lower layer), the lowest layer of the Laplacian pyramid is equal to the lowest layer of the Gaussian pyramid (i.e., the 9 pixels in FIG. 6A, excluding the interpolated pixels).

Reference is made to FIG. 3. In some embodiments, the Laplacian pyramid calculation circuit 340 stores the Laplacian pyramid into the memory 370 and then sends out a trigger signal BS to notify the blending circuit 350 to start operation. The blending circuit 350 performs a blending operation on two Laplacian pyramids in the memory 370 (each belonging to one of the two images to be stitched) to produce a blended pyramid, then stores the blended pyramid into the memory 370 and sends out a trigger signal CS. The reconstruction circuit 360 then performs upsampling on the blended pyramid to generate the stitched image tile, which is stored in the memory 302.

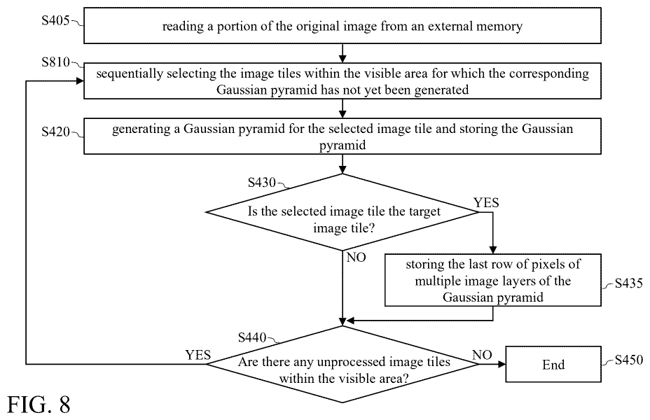

Reference is made to FIG. 1 and FIG. 4. According to the above discussion, when the target image tile is the image tile T_k_p−1, the Gaussian pyramid calculation circuit 310 needs to calculate the Gaussian pyramid of the 6 image tiles: T_k_p−2 (not shown), T_k_p−1, T_k_p, T_k+1_p−2 (not shown), T_k+1_p−1, and T_k+1_p. Additionally, when the target image tile is the image tile T_k_p, the Gaussian pyramid calculation circuit 310 needs to calculate the Gaussian pyramid of the 6 image tiles: T_k_p−1, T_k_p, T_k_p+1, T_k+1_p−1, T_k+1_p, and T_k+1_p+1. In other words, since the visible area of the image tile T_k_p−1 partially overlaps with the visible area 110 of the image tile T_k_p, for the adjacent image tiles of the same slice (e.g., T_k_p−1 and T_k_p), the Gaussian pyramid calculation circuit 310 redundantly calculates the Gaussian pyramid of some image tiles in the visible area. Therefore, according to another embodiment of the present invention, a flowchart for generating the Gaussian pyramid (FIG. 8) is proposed to further reduce the amount of computation. FIG. 8 is a part of the image processing method (image stitching) of the present invention. The process of FIG. 8 includes step S405, step S810, and steps S420 to S450, where step S405 and steps S420 to S450 are substantially the same as step S405 and steps S420 to S450 of FIG. 4.

Step S810: The Gaussian pyramid calculation circuit 310 sequentially selects the image tiles within the visible area for which the corresponding Gaussian pyramid has not yet been generated. Reference is made to FIG. 1. The Gaussian pyramid of the image tile T_k_p and the Gaussian pyramid of the image tile T_k+1_p are generated when the target image tile is the image tile T_k_p−1. Therefore, when the target image tile is the image tile T_k_p, the image tiles for which the corresponding Gaussian pyramid has not yet been generated include the image tile T_k_p+1 and the image tile T_k+1_p+1, which are located to the right and the lower right of the image tile T_k_p, respectively. That is to say, in this step, the Gaussian pyramid calculation circuit 310 selects the image tile T_k_p+1. When executing step S810 for the second time (when the result of step S440 is YES), the Gaussian pyramid calculation circuit 310 selects the image tile T_k+1_p+1.

Continuing the previous paragraph, when the target image tile is the image tile T_k−1_p, the Gaussian pyramid calculation circuit 310 generates the Gaussian pyramid of the image tile T_k_p+1. However, in some embodiments, when the visible area 110 does not contain the image tile T_k_p+1, the Gaussian pyramid of the image tile T_k_p+1 is deleted from the memory 330 to save memory space.

It should be noted that when the image processing circuit 301 is processing the image tile T_k_p (i.e., when the target image tile is the image tile T_k_p), the memory 330 has stored the Gaussian pyramid of the image tile T_k_p, which was generated when the target image tile was the image tile T_k_p−1. Therefore, in the embodiment of FIG. 8, when the image processing circuit 301 is processing the image tile T_k_p, the Gaussian pyramid calculation circuit 310 does not need to calculate the Gaussian pyramid of the image tiles T_k_p−1, T_k_p, T_k+1_p−1, and T_k+1_p again because the Gaussian pyramids have been calculated and stored in the second buffer circuit 334 before the image tile T_k_p becomes the target image tile. This further reduces the amount of computation.

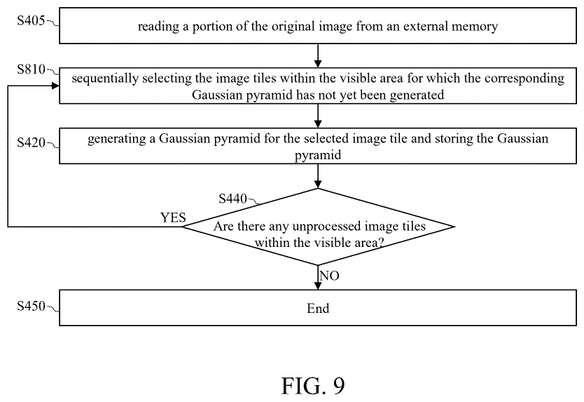

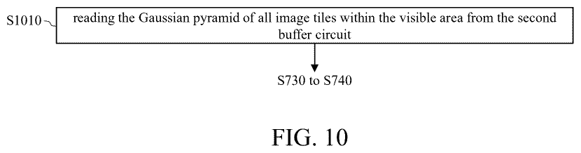

Reference is made to FIG. 9 and FIG. 10. FIG. 9 is a flowchart for generating the Gaussian pyramid according to another embodiment of the present invention, and FIG. 10 is a flowchart for generating the Laplacian pyramid according to another embodiment of the present invention. FIGS. 9 and 10 correspond to each other, and both are a part of the image processing method (image stitching) of the present invention. FIG. 9 is similar to FIG. 8, except that in the embodiment of FIG. 9, the Gaussian pyramid calculation circuit 310 does not additionally store the pixels of the last row of multiple image layers of the Gaussian pyramid of the target image tile (i.e., does not perform step S430 and step S435). Correspondingly, in the process of FIG. 10, the Laplacian pyramid calculation circuit 340 reads the Gaussian pyramid of all image tiles within the visible area 110 from the second buffer circuit 334 through the second buffer control circuit 324 (step S1010). For comparison (refer to FIG. 1), in the embodiment of FIG. 4 and FIG. 7, the complete Gaussian pyramid of the image tile T_k_p−1 only needs to be retained until the Laplacian pyramid corresponding to the image tile T_k_p is generated, whereas in the embodiment of FIG. 9 and FIG. 10, the complete Gaussian pyramid of the image tile T_k_p−1 needs to be retained until the Laplacian pyramid corresponding to the image tile T_k+1_p is generated. However, compared to the conventional technology (which does not store the Gaussian pyramid corresponding to the overlapping visible area), the embodiment in FIG. 9 and FIG. 10 can reduce the amount of computation by approximately two-thirds.

The image stitching operation is intended to illustrate the invention by way of example and not to limit the scope of the claimed invention. People having ordinary skill in the art may apply the present invention to other types of image processing in accordance with the foregoing discussions.

Various functional components or blocks have been described herein. As appreciated by persons skilled in the art, in some embodiments, the functional blocks can preferably be implemented through circuits (either dedicated circuits, or general purpose circuits, which operate under the control of one or more processors and coded instructions), which typically comprise transistors or other circuit elements that are configured in such a way as to control the operation of the circuitry in accordance with the functions and operations described herein. As further appreciated by persons skilled in the art, the specific structure or interconnections of the circuit elements can typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An image processing circuit coupled to an external memory and configured to perform an image stitching operation, the external memory storing an original image, the original image containing a first slice and a second slice that are adjacent to each other, the first slice containing a first image tile, the image processing circuit sequentially processing the first slice and the second slice, the image processing circuit comprising:
a memory;
a memory control circuit coupled to the memory;
a Gaussian pyramid calculation circuit coupled to the memory control circuit and configured to perform following steps:
reading a portion of the original image from the external memory;
generating a Gaussian pyramid for the first image tile, wherein the Gaussian pyramid includes N image layers, and N is a positive integer greater than one;
storing N−1 rows of pixels into the memory through the memory control circuit, wherein the N−1 rows of pixels are respectively the last row of N−1 image layers among the N image layers; and
storing the Gaussian pyramid into the memory through the memory control circuit; and
a Laplacian pyramid calculation circuit coupled to the Gaussian pyramid calculation circuit and the memory control circuit and configured to perform following steps:
reading the N−1 rows of pixels from the memory when generating a corresponding Laplacian pyramid for a second image tile of the second slice.

2. The image processing circuit of claim 1, wherein the first image tile is located within a visible area centered on the second image tile.

3. The image processing circuit of claim 1, wherein the Gaussian pyramid is a first Gaussian pyramid, the original image contains a visible area centered on the second image tile, the visible area contains a third image tile, the image processing circuit processes the second image tile first and then processes the third image tile, and the Gaussian pyramid calculation circuit further performs following steps:
generating a second Gaussian pyramid for the third image tile, and storing the second Gaussian pyramid into the memory.

4. The image processing circuit of claim 3, wherein when the image processing circuit is processing the second image tile, the memory has already stored a third Gaussian pyramid of the second image tile, and the Laplacian pyramid calculation circuit reads the third Gaussian pyramid from the memory.

5. The image processing circuit of claim 4, wherein the third image tile is located in the second slice, and the image processing circuit sequentially processes the second image tile and the third image tile.

6. The image processing circuit of claim 4, wherein the third image tile is located in a third slice and is located to the lower right of the second image tile, and the image processing circuit sequentially processes the second slice and the third slice.

7. An image processing method of performing an image stitching operation, the image processing method comprising:
reading a portion of an original image from an external memory, wherein the original image contains a first slice and a second slice that are adjacent to each other, the first slice contains a first image tile, and the image processing method sequentially processes the first slice and the second slice;
generating a Gaussian pyramid for the first image tile, wherein the Gaussian pyramid includes N image layers, and N is a positive integer greater than one;
storing N−1 rows of pixels into a memory, wherein the N−1 rows of pixels are respectively the last row of N−1 image layers among the N image layers;
storing the Gaussian pyramid into the memory; and
reading the N−1 rows of pixels from the memory when generating a corresponding Laplacian pyramid for a second image tile of the second slice.

8. The image processing method of claim 7, wherein the first image tile is located within a visible area of the second image tile.

9. The image processing method of claim 7, wherein the Gaussian pyramid is a first Gaussian pyramid, the original image contains a visible area centered on the second image tile, the visible area contains a third image tile, the image processing method processes the second image tile first and then processes the third image tile, and the image processing method further comprises:
generating a second Gaussian pyramid for the third image tile, and storing the second Gaussian pyramid into the memory.

10. The image processing method of claim 9, wherein when the image processing method is processing the second image tile, the memory has already stored a third Gaussian pyramid of the second image tile, and the step of generating the corresponding Laplacian pyramid further reads the third Gaussian pyramid from the memory.

11. The image processing method of claim 10, wherein the third image tile is located in the second slice, and the image processing method sequentially processes the second image tile and the third image tile.

12. The image processing method of claim 10, wherein the third image tile is located in a third slice and is located to the lower right of the second image tile, and the image processing method sequentially processes the second slice and the third slice.

13. An image processing circuit coupled to an external memory and configured to perform an image stitching operation, the external memory storing an original image, the original image containing a visible area centered on a first image tile, the visible area containing a second image tile, the image processing circuit processing the first image tile first and then processing the second image tile, the first image tile and the second image tile corresponding to a first Gaussian pyramid and a second Gaussian pyramid, respectively, the image processing circuit comprising:
a memory;
a memory control circuit coupled to the memory;
a Gaussian pyramid calculation circuit coupled to the memory control circuit; and
a Laplacian pyramid calculation circuit coupled to the Gaussian pyramid calculation circuit and the memory control circuit;
wherein when the image processing circuit is processing the first image tile, the memory has already stored the first Gaussian pyramid of the first image tile, the Gaussian pyramid calculation circuit generates the second Gaussian pyramid for the second image tile and stores the second Gaussian pyramid into the memory, and the Laplacian pyramid calculation circuit reads the first Gaussian pyramid from the memory.

14. The image processing circuit of claim 13, wherein the original image contains a slice, the slice contains the first image tile and the second image tile, and the image processing circuit sequentially processes the first image tile and the second image tile.

15. The image processing circuit of claim 13, wherein the original image contains a first slice and a second slice that are adjacent to each other, the first slice contains the first image tile, the second slice contains the second image tile, and the image processing circuit sequentially processes the first slice and the second slice.

16. The image processing circuit of claim 15, wherein the second image tile is located to the lower right of the first image tile.
